(19) United States
(12) Patent Application Publication
(10) Pub. No.: US 2015/0156846 A1
(43) Pub. Date: Jun. 4, 2015

(54) OVER-CURRENT PROTECTION CIRCUIT, LED BACKLIGHT DRIVING CIRCUIT AND LIQUID CRYSTAL DEVICE

(71) Applicant: Dan Cao, Shenzhen City (CN)

(72) Inventor: Dan Cao, Shenzhen City (CN)

(73) Assignee: Shenzhen China Star Optoelectronics Technology Co. Ltd, Shenzhen, Guangdong (CN)

(21) Appl. No.: 14/131,870

(22) PCT Filed: Dec. 2, 2013
(86) PCT No.: PCT/CN2013/088290

§ 371 Date: Jan. 9, 2014

(51) Int. Cl. H05B 33/08; G02F 1/1335; G09G 3/34; H02H 9/02

(52) U.S. Cl. CPC H05B 33/0887; H02H 9/02; H05B 33/083; G02F 1/133603; G09G 3/342; G09G 2330/00

(57) ABSTRACT

An over-current protection circuit includes a boost circuit, a voltage control module and an over-current protection module. The boost circuit boosts an input direct current (DC) voltage to a boosted DC voltage and for providing the boosted DC voltage to a load. The voltage control module controls the boost circuit to provide the boosted DC voltage to the load such that the load is driven by a constant current. The over-current protection module generates first control signals or second control signals according to an over-current protection voltage detected by the boost circuit. The first control signals are for controlling the voltage control module to operate normally, and the second control signals are for stopping operations of the voltage control module. In addition, the LED backlight driving circuit and the liquid crystal device incorporating the above over-current protection circuit are also disclosed.

### BACKGROUND OF THE INVENTION

1. Field of the Invention

The present disclosure relates to liquid crystal display technology, and more particularly to an over-current protection circuit, the LED backlight driving circuit with the over-current protection circuit and the liquid crystal display (LCD) with the LED backlight driving circuit.

2. Discussion of the Related Art

With the technical evolution, the backlight technology for the LCDs have been developed. In the past, CCFLs are adopted as backlight source. However, LEDs have now been adopted as backlight sources for the reason that the CCFLs have the disadvantages, such as low color restoration, low lighting efficiency, high discharging voltage, bad discharging characteristics at low temperature, and long heating time to achieve stable gray level. Generally, the LED backlight source is arranged opposite to the liquid crystal panel so as to provide the light source to the liquid crystal panel. A specific LED backlight source driving circuit is adopted to provide a driving voltage such that the LED string can emit light normally.

FIG. 1 is a schematic view of a typical LED backlight driving circuit. As shown, the LED backlight driving circuit includes a boost circuit 110, a backlight driving chip (IC) 120 and a LED string 130. The LED string 130 includes a plurality of LEDs that are serially connected, a second MOS transistor Q2 and a resistor R1.

The boost circuit 110 is controlled by the backlight driving chip 120 to boost a direct current (DC) voltage Vin so as to satisfy the demand of the LED string 130. At the same time, the backlight driving chip 120 control the current passing through the backlight driving chip 120 such that the backlight driving chip 120 can emit light normally.

However, the pin (ISEN) of the backlight driving chip 120 determines to stop its operations when the current passing the second resistor (R2) is larger than the tolerated state for a duration. When the rectifier diode D of the boost circuit is shorted connected, a huge amount of current passing the first MOS transistor Q1 and the resistor R2 when the first MOS transistor Q1 is turn on for the reason that the capacitor C1 stores a huge amount of energy. Thus, the first MOS transistor Q1 and the second resistor (R2) are burn out.

### SUMMARY

In one aspect, an over-current protection circuit includes: a boost circuit for boosting an input direct current (DC) voltage to a boosted DC voltage and for providing the boosted DC voltage to a load; a voltage control module for controlling the boost circuit to provide the boosted DC voltage to the load such that the load is driven by a constant current; and an over-current protection module for generating first control signals or second control signals according to an over-current protection voltage detected by the boost circuit, the first control signals are for controlling the voltage control module to operate normally, and the second control signals are for stopping operations of the voltage control module.

Wherein the over-current protection module generates the first control signals when the over-current protection voltage is smaller than a reference voltage, and the over-current protection module generates the second control signals when the over-current protection voltage is larger than the reference voltage.

In another aspect, a LED backlight driving circuit includes: a boost circuit for boosting a DC voltage to a boosted DC voltage and for providing the boosted DC voltage to a load; a voltage control module for controlling the boost circuit to provide the boosted DC voltage to the load such that the load is driven by a constant current; and an over-current protection module for generating first control signals or second control signals according to an over-current protection voltage detected by the boost circuit, the first control signals are for controlling the voltage control module to operate normally, and the second control signals are for stopping operations of the voltage control module.

Wherein the over-current protection module generates the first control signals when the over-current protection voltage is smaller than a reference voltage, and the over-current protection module generates the second control signals when the over-current protection voltage is larger than the reference voltage.

Wherein the over-current protection module comprises a comparing unit and a control unit, the comparing unit compares the over-current protection voltage with the reference voltage and then outputs a comparing result, and the control unit generates the first control signals or the second control signals according to the comparing result.

Wherein the comparing unit comprises a comparator and the control unit comprises a second MOS transistor, and wherein a positive input end of the comparator couples between the boost circuit and the second resistor, a negative end of the comparing unit is for receiving the reference voltage, an output end of the comparator couples with a gate of the second MOS transistor, a source of the second MOS transistor is electrically grounded, and a drain of the second MOS transistor couples with an enable end of the voltage control module.

Wherein the comparator outputs the low-level signals to the gate of the second MOS transistor when the over-current protection voltage is smaller than the reference voltage such that the enable end of the voltage control module receives the first control signals, and the comparator outputs the high-level signals to the gate of the second MOS transistor when the over-current protection voltage is larger than the reference voltage such that the enable end of the voltage control module receives the second control signals.

Wherein the boost circuit comprises a charging-discharging module, when the voltage control module outputs turn-un signals to the boost circuit, the charging-discharging module provides the boosted DC voltage to the LED string, and when the voltage control module outputs the turn-off signals to the boost circuit, the charging-discharging module is charged.

Wherein the boosted circuit further comprises an inductor, a rectifier diode, and a first MOS transistor, wherein One end of the inductor is for receiving the input DC voltage, and the other end of the inductor couples with the positive end of the rectifier diode, the negative end of the rectifier diode couples with the positive end of the LED string, one end of the charging-discharging module couples between the negative end of the rectifier diode and the positive end of the LED string, the other end of the charging-discharging module is electrically grounded, the drain of the first MOS transistor couples between the other end of the inductor and the positive end of the rectifier diode, the source of the first MOS transistor couples with the second resistor, and the gate of the first MOS transistor couples with the voltage control module.

In another aspect, a liquid crystal device includes a liquid crystal panel and a LED backlight source arranged opposite to the liquid crystal panel, the LED backlight source provides a display light source to the liquid crystal panel such that the liquid crystal panel is capable of displaying images, and the LED backlight source includes the above LED backlight driving circuit.

In view of the above, the control signals for controlling the voltage control module to operate normally or to stop its operations are generated in accordance with the over-current protection voltage. As such, when the over-current protection voltage surges and exceeds the reference voltage, the over-current protection module generates the control signals to stop the operations of the voltage control module. In this way, the voltage control module stops its operations and the circuit components are prevented from being burn out due to the surged current.

### BRIEF DESCRIPTION OF THE DRAWINGS

FIG. 1 is a schematic view of the typical LED backlight driving circuit.

FIG. 2 is a module diagram of the over-current protection circuit in accordance with one embodiment.

FIG. 3 is a schematic view of the LED backlight driving circuit in accordance with one embodiment.

FIG. 4 is a schematic view of the liquid crystal device incorporating the LED backlight driving circuit of FIG. 3.

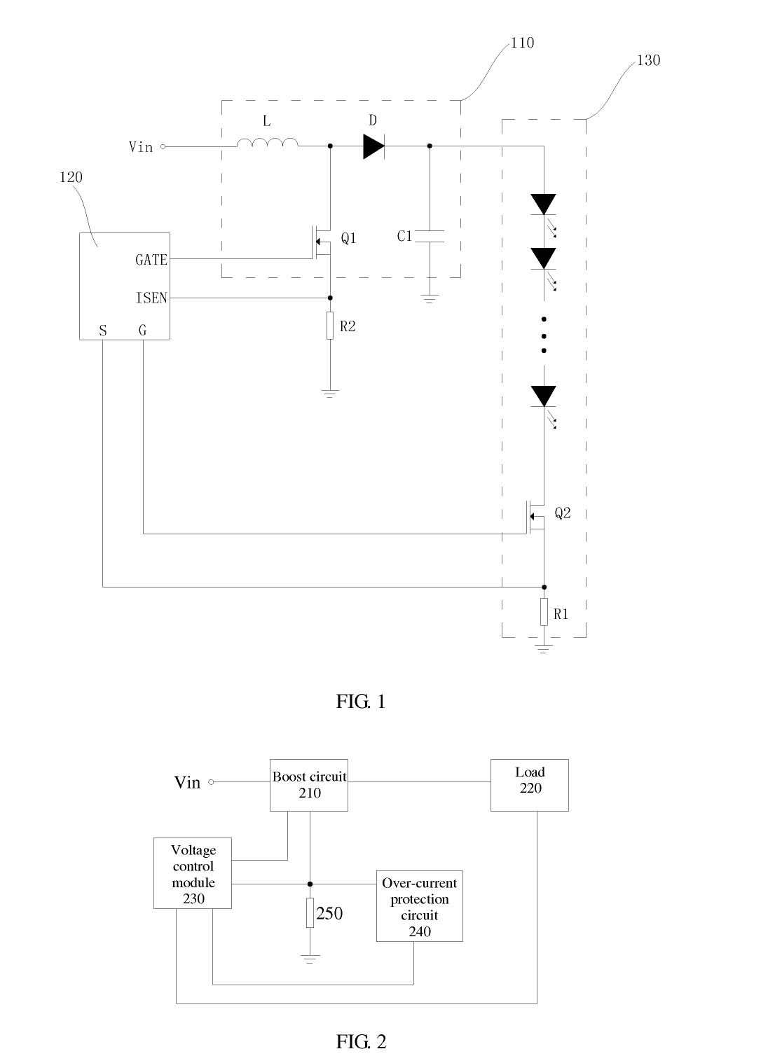

### DETAILED DESCRIPTION OF THE EMBODIMENTS

Embodiments of the invention will now be described more fully hereinafter with reference to the accompanying drawings, in which embodiments of the invention are shown.

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

FIG. 2 is a module diagram of the over-current protection circuit in accordance with one embodiment.

Referring to FIG. 2, the over-current protection circuit includes a boost circuit 210, a voltage control module 230, and an over-current protection module 240. The boost circuit 210 is configured for boosting the input DC voltage (Vin) to a boosted DC voltage, which is the voltage needed by a load 220. The boost circuit 210 then provides the boosted DC voltage to the load 220. The voltage control module 230 is configured for controlling the boost circuit 210 such that the boost circuit 210 boosts the input DC voltage (Vin) to the voltage needed by the load 220 and then provides the boosted DC voltage to the load 220. Thus, the load 220 is driven by a constant current. The over-current protection module 240 is configured for generating first control signals or second control signals according to an over-current protection voltage detected by the boost circuit 210, that is, the voltage between a second resistor 250 and the boost circuit 210. The first control signals are for controlling the voltage control module 230 to operate normally, and the second control signals are for stopping the operation of the voltage control module 230. The over-current protection voltage is the product of the resistance of the second resistor 250 and the amount of the current passing through the second resistor 250.

When the over-current protection voltage is smaller than a reference voltage, the over-current protection module 240 generates the first control signals. When the over-current protection voltage is larger than the reference voltage, the over-current protection module 240 generates the second control signals.

The over-current protection circuit generates control signals to enable or disable the voltage control module 230 according to the over-current protection voltage detected by the over-current protection module 240 such that when the over-current protection voltage surges and exceeds the reference voltage, the over-current protection module 240 generates the control signals to stop the operations of the voltage control module 230. Thus, the voltage control module 230 stops its operations and the circuit components are prevented from being burn out due to the surged current.

As stated above, the over-current protection circuit may be adopted in the LED backlight driving circuit for the LED backlight source. In the embodiment, the load 220 of the over-current protection circuit may be, but not limited to, the LED string.

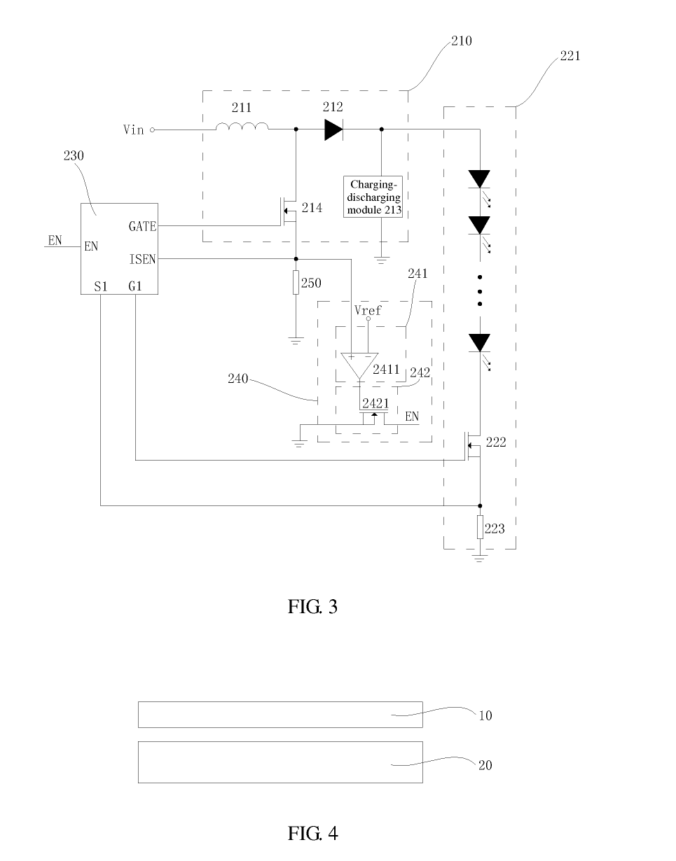

FIG. 3 is a schematic view of the LED backlight driving circuit in accordance with one embodiment.

As shown, the LED backlight driving circuit includes the boost circuit 210, the voltage control module 230, the over-current protection module 240, and the LED string 221. The LED string 221 includes a plurality of LEDs that are serially connected, and a plurality of third Metal Oxide Semiconductor (MOS) transistors 222, and a first resistor 223.

Specifically, the boost circuit 210 includes a charging-discharging module 213. When the voltage control module 230 outputs turn-un signals (high-level signals) to the boost circuit 210, the charging-discharging module 213 provides the boosted DC voltage to the LED string 221. When the voltage control module 230 outputs the turn-off signals (low-level signals) to the boost circuit 210, the charging-discharging module 213 is charged. The charging-discharging module 213 may be, but not limited to, capacitors.

In addition, the boost circuit 210 further includes an inductor 211, a rectifier diode 212, and a first MOS transistor 214. One end of the inductor 211 is for receiving the input DC voltage (Vin), and the other end of the inductor 211 couples with the positive end of the rectifier diode 212. The negative end of the rectifier diode 212 couples with the positive end of the LED string 221. One end of the charging-discharging module 213 couples between the negative end of the rectifier diode 212 and the positive end of the LED string. The other end of the charging-discharging module 213 is electrically grounded. The drain of the first MOS transistor couples between the other end of the inductor 211 and the positive end of the rectifier diode 212. The source of the first MOS transistor 214 couples with the second resistor 250. The gate of the first MOS transistor 214 couples with the voltage control module 230. The voltage control module 230 controls the boost circuit 210 by controlling the driving signals outputted to the gate of the first MOS transistor 214. As such, the boost circuit 210 boosts the input DC voltage (Vin) to the voltage enabling the LED string 221 to emit light normally, and provides the boosted voltage to the LED string 221.

The voltage control module 230 may be backlight driving integrated circuits (IC) including a plurality of pins. The GATE pin of the voltage control module 230 couples with the gate of the first MOS transistor 214 for providing the driving signals, including the above turn-on signals and turn-off signals, of the boost circuit 210 to the gate of the first MOS transistor 214. The ISEN pin of the voltage control module 230 couples between the source of the first MOS transistor 214 and the second resistor 250 for detecting the over-current protection voltage of the boost circuit 210, which is the voltage between the source of the first MOS transistor 214 and the second resistor 250. When the detected over-current protection voltage is larger than a protection voltage, which is the default voltage of the voltage control module 230, the voltage control module 230 stops its operation. The EN pin of the voltage control module 230, i.e., the enable end of the voltage control module 230, couples with the over-current protection module 240. When the high-level signals are inputted to the EN pin, the voltage control module 230 operates normally. When the low-level signals are inputted to the EN pin, the voltage control module 230 stops its operation. The G1 pin of the voltage control module 230 couples with the gate of the third MOS transistor 222. The S1 pin of the voltage control module 230 couples between the source of the third MOS transistor 222 and the first resistor 223 for keeping the current constantly passing through the LED string 221 and for adjusting the amount of the current passing through the LED string 221 such that the LED string 221 emit light normally.

The over-current protection module 240 includes a comparing unit 241, and a control unit 242. The comparing unit 241 compares the over-current protection voltage detected by the voltage control module 230 with the reference voltage (Vref) and outputs the comparing result. The control unit 242 generates the first control signals or the second control signals according to the comparing result. The first control signals are for controlling the voltage control module 230 to operate normally, and the second control signals are for controlling the voltage control module 230 to stop its operation.

The comparing unit 241 includes a comparator 2411. The control unit 242 includes a second MOS transistor 2421. The positive input end of the comparator 2411 couples between the source of the first MOS transistor 214 of the boost circuit 210 and the second resistor 250. The negative end of the comparing unit 241 is for receiving the reference voltage (Vref). The output end of the comparator 2411 couples with the gate of the second MOS transistor 2421. The source of the second MOS transistor 2421 is electrically grounded. The drain of the second MOS transistor 2421 couples with the EN pin of the voltage control module 230. The comparator 2411 outputs the low-level signals to the gate of the second MOS transistor 2421 when the over-current protection voltage detected by the voltage control module 230 is smaller than the reference voltage (Vref). As such, the second MOS transistor 2421 is turn off and the EN pin of the voltage control module 230 receives the first control signals so as to operate normally. The comparator 2411 outputs the high-level signals to the gate of the second MOS transistor 2421 when the over-current protection voltage detected by the voltage control module 230 is larger than the reference voltage (Vref). As such, the second MOS transistor 2421 is turn on and the EN pin of the voltage control module 230 receives the second control signals so as to stop its operations.

In the embodiment, the first control signals may be, but not limited to, low-level signals, and the second control signals may be, but not limited to, high-level signals.

In the embodiment, the plurality of LEDs 221 connected in parallel couple with the positive end of the rectifier diode 212 of the boost circuit 210. The LED string 221 may be driven as long as the boosted voltage outputted by the boost circuit 210 is large enough. As such, the LED backlight source is capable of providing more light to the liquid crystal panel.

The over-current protection functions of the LED backlight driving circuit will be described hereinafter with reference to FIG. 3. During the normal operations of the LED backlight driving circuit, the LED string 221 receives the input DC voltage (Vin) from the boost circuit 210 and then boosts the input DC voltage (Vin) so as to emit lights normally. At this moment, the current passing through the first MOS transistor 214 and the second resistor 250 equals to I1. As the over-current protection voltage detected by the voltage control module 230 is smaller than the reference voltage (Vref), the output end of the comparator 2411 outputs the low-level signals to the gate of the second MOS transistor 2421 so as to turn off the second MOS transistor 2421. The over-current protection voltage is the voltage between the source of the first MOS transistor 214 and the second resistor 250. The over-current protection voltage is the product of I1 and R, and R represent the resistance of the second resistor 250. As a result, the EN pin of the voltage control module 230 receives the first control signals, i.e., the high-level signals, but remains its normal operations.

When the LED backlight driving circuit operates abnormally, such as when the rectifier diode 212 of the boost circuit 210 is shorted, the charging-discharging module 213 of the boost circuit 210 stores a large amount of energy. When the first MOS transistor 214 is turn on, the surged current passing through the first MOS transistor 214 and the second resistor 250. At this moment, the amount of the current passing through the first MOS transistor 214 and the second resistor 250 equals to I2. As the over-current protection voltage detected by the voltage control module 230 is larger than the reference voltage (Vref), the output end of the comparator 2411 outputs the high-level signals to the gate of the second MOS transistor 2421 so as to turn on the second MOS transistor 2421. The over-current protection voltage relates to the voltage between the source of the first MOS transistor 214 and the second resistor 250. The over-current protection voltage is the product of I1 and R, and R represents the resistance of the second resistor 250. The source of the second MOS transistor 2421 is electrically grounded such that the EN pin of the voltage control module 230 transits to the low-level signals. Similarly, the EN pin of the voltage control module 230 receives the second control signals, i.e., the low-level signals, to stop its operations. At the same time, the first MOS transistor 214 and the second resistor 250 are prevented from being damaged due to the current I2 passing through the first MOS transistor 214 and the second resistor 250.

The liquid crystal device incorporating with the LED backlight driving circuit of FIG. 3 will be described hereinafter. FIG. 4 is a schematic view of the liquid crystal device incorporating the LED backlight driving circuit of FIG. 3.

Referring to FIG. 4, the liquid crystal device includes a liquid crystal panel 10 and a LED backlight source 20 arranged opposite to the liquid crystal panel 10. The LED backlight source 20 provides a display light source 20 to the liquid crystal panel 10 such that the liquid crystal panel 10 can display images. The display light source 20 includes the LED backlight driving circuit of FIG. 3.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An over-current protection circuit, comprising:
a boost circuit for boosting an input direct current (DC) voltage to a boosted DC voltage and for providing the boosted DC voltage to a load;
a voltage control module for controlling the boost circuit to provide the boosted DC voltage to the load such that the load is driven by a constant current; and
an over-current protection module for generating first control signals or second control signals according to an over-current protection voltage detected by the boost circuit, the first control signals are for controlling the voltage control module to operate normally, and the second control signals are for stopping operations of the voltage control module.

2. The over-current protection circuit as claimed in claim 1, wherein the over-current protection module generates the first control signals when the over-current protection voltage is smaller than a reference voltage, and the over-current protection module generates the second control signals when the over-current protection voltage is larger than the reference voltage.

3. A LED backlight driving circuit, comprising:
a boost circuit for boosting a DC voltage to a boosted DC voltage and for providing the boosted DC voltage to a load;
a voltage control module for controlling the boost circuit to provide the boosted DC voltage to the load such that the load is driven by a constant current; and
an over-current protection module for generating first control signals or second control signals according to an over-current protection voltage detected by the boost circuit, the first control signals are for controlling the voltage control module to operate normally, and the second control signals are for stopping operations of the voltage control module.

4. The LED backlight driving circuit as claimed in claim 3, wherein the over-current protection module generates the first control signals when the over-current protection voltage is smaller than a reference voltage, and the over-current protection module generates the second control signals when the over-current protection voltage is larger than the reference voltage.

5. The LED backlight driving circuit as claimed in claim 3, wherein the over-current protection module comprises a comparing unit and a control unit, the comparing unit compares the over-current protection voltage with the reference voltage and then outputs a comparing result, and the control unit generates the first control signals or the second control signals according to the comparing result.

6. The LED backlight driving circuit as claimed in claim 5, wherein the comparing unit comprises a comparator and the control unit comprises a second MOS transistor, and wherein a positive input end of the comparator couples between the boost circuit and the second resistor, a negative end of the comparing unit is for receiving the reference voltage, an output end of the comparator couples with a gate of the second MOS transistor, a source of the second MOS transistor is electrically grounded, and a drain of the second MOS transistor couples with an enable end of the voltage control module.

7. The LED backlight driving circuit as claimed in claim 6, wherein the comparator outputs the low-level signals to the gate of the second MOS transistor when the over-current protection voltage is smaller than the reference voltage such that the enable end of the voltage control module receives the first control signals, and the comparator outputs the high-level signals to the gate of the second MOS transistor when the over-current protection voltage is larger than the reference voltage such that the enable end of the voltage control module receives the second control signals.

8. The LED backlight driving circuit as claimed in claim 3, wherein the boost circuit comprises a charging-discharging module, when the voltage control module outputs turn-un signals to the boost circuit, the charging-discharging module provides the boosted DC voltage to the LED string, and when the voltage control module outputs the turn-off signals to the boost circuit, the charging-discharging module is charged.

9. The LED backlight driving circuit as claimed in claim 8, wherein the boosted circuit further comprises an inductor, a rectifier diode, and a first MOS transistor, wherein One end of the inductor is for receiving the input DC voltage, and the other end of the inductor couples with the positive end of the rectifier diode, the negative end of the rectifier diode couples with the positive end of the LED string, one end of the charging-discharging module couples between the negative end of the rectifier diode and the positive end of the LED string, the other end of the charging-discharging module is electrically grounded, the drain of the first MOS transistor couples between the other end of the inductor and the positive end of the rectifier diode, the source of the first MOS transistor couples with the second resistor, and the gate of the first MOS transistor couples with the voltage control module.

10. A liquid crystal device comprising a LED backlight driving circuit, the LED backlight driving circuit comprising:
a boost circuit for boosting a DC voltage to a boosted DC voltage and for providing the boosted DC voltage to a load;
a voltage control module for controlling the boost circuit to provide the boosted DC voltage to the load such that the load is driven by a constant current; and
an over-current protection module for generating first control signals or second control signals according to an over-current protection voltage detected by the boost circuit, the first control signals are for controlling the voltage control module to operate normally, and the second control signals are for stopping operations of the voltage control module.

11. The liquid crystal device as claimed in claim 10, wherein the over-current protection module generates the first control signals when the over-current protection voltage is smaller than a reference voltage, and the over-current protection module generates the second control signals when the over-current protection voltage is larger than the reference voltage.

12. The liquid crystal device as claimed in claim 10, wherein the over-current protection module comprises a comparing unit and a control unit, the comparing unit compares the over-current protection voltage with the reference voltage and then outputs a comparing result, and the control unit generates the first control signals or the second control signals according to the comparing result.

13. The liquid crystal device as claimed in claim 12, wherein the comparing unit comprises a comparator and the control unit comprises a second MOS transistor, and wherein a positive input end of the comparator couples between the boost circuit and the second resistor, a negative end of the comparing unit is for receiving the reference voltage, an output end of the comparator couples with a gate of the second MOS transistor, a source of the second MOS transistor is electrically grounded, and a drain of the second MOS transistor couples with an enable end of the voltage control module.

14. The liquid crystal device as claimed in claim 13, wherein the comparator outputs the low-level signals to the gate of the second MOS transistor when the over-current protection voltage is smaller than the reference voltage such that the enable end of the voltage control module receives the first control signals, and the comparator outputs the high-level signals to the gate of the second MOS transistor when the over-current protection voltage is larger than the reference voltage such that the enable end of the voltage control module receives the second control signals.

15. The liquid crystal device as claimed in claim 10, wherein the boost circuit comprises a charging-discharging module, when the voltage control module outputs turn-un signals to the boost circuit, the charging-discharging module provides the boosted DC voltage to the LED string, and when the voltage control module outputs the turn-off signals to the boost circuit, the charging-discharging module is charged.

16. The liquid crystal device as claimed in claim 15, wherein the boosted circuit further comprises an inductor, a rectifier diode, and a first MOS transistor, wherein One end of the inductor is for receiving the input DC voltage, and the other end of the inductor couples with the positive end of the rectifier diode, the negative end of the rectifier diode couples with the positive end of the LED string, one end of the charging-discharging module couples between the negative end of the rectifier diode and the positive end of the LED string, the other end of the charging-discharging module is electrically grounded, the drain of the first MOS transistor couples between the other end of the inductor and the positive end of the rectifier diode, the source of the first MOS transistor couples with the second resistor, and the gate of the first MOS transistor couples with the voltage control module.
